(19) United States
(12) Patent Application Publication
(10) Pub. No.: US 2026/0025335 A1
(43) Pub. Date: Jan. 22, 2026

(54) Intelligent Traffic Prediction Module Integrated in Quality-of-Service (QoS)-Based Dynamic Bandwidth Allocation System and Method for Cable and Optical Data Networks

(71) Applicant: Beegol Corporation, Sao Paulo (BR)

(72) Inventors: Gilberto Mayor, Sao Paulo (BR); Sergio Campos, Sao Paulo (BR)

(21) Appl. No.: 19/311,730

(22) Filed: Aug. 27, 2025

Related U.S. Application Data
(63) Continuation-in-part of application No. 18/778,966, filed on Jul. 20, 2024.

(51) Int. Cl. H04L 47/24; H04L 47/215

(52) U.S. Cl. CPC H04L 47/24; H04L 47/215

(57) ABSTRACT

A novel dynamic bandwidth allocation system integrates an intelligent traffic prediction module and an on-demand token replenishment module in a quality-of-service (QoS)-based media access control (MAC) layer controller, which is able to dynamically allocate data transmission capacity (i.e., bandwidth) to multiple incoming service flows of data packets for multiple subscribers more efficiently with less network congestions and service inconsistencies than conventional MAC layer management methods. The novel dynamic bandwidth allocation system utilizes network traffic predictions to identify potentially sudden or rapid changes in near-term network traffic, and if necessary, adjusts bandwidth allocations preemptively to service flows to minimize service quality degradations while also improving network resource usage efficiencies, compared to conventional static bandwidth allocation methods. The novel dynamic bandwidth allocation system also minimizes unnecessary packet droppages, network congestions, and/or speed degradations during bursty and oscillating network traffic, and improves QoS satisfaction rates for network subscribers.

### RELATED APPLICATION

The present application is a continuation-in-part (CIP) application to a pending non-provisional application, U.S. Ser. No. 18/778,966, which was filed on Jul. 20, 2024. The contents of U.S. Ser. No. 18/778,966 are fully incorporated by reference in the present application.

### BACKGROUND OF THE INVENTION

The present invention generally relates to one or more electronic systems and methods for improving speed and efficiency in cable and/or optical data networks. The present invention also relates to one or more systems and methods for improving the functioning of a computer and computer networks. More specifically, various embodiments of the present invention relate to quality of service (QoS)-based dynamic bandwidth allocation methods and systems that improve speed and efficiency of cable and/or optical data networks. Furthermore, various embodiments of the present invention also relate to an intelligent traffic prediction module integrated in a QoS-based dynamic bandwidth allocation system and a method of operating such a system.

In an Open System Interconnections (OSI) model for data networks, a media access control (MAC) layer is a sublayer of the data link layer, which accommodates node-to-node data transfers. The data link layer detects, and if desired, corrects errors that may occur in the physical layer. The data link defines the protocol to establish and terminate a connection between two physically connected devices and also defines the protocol for flow control between nodes. The primary function of the MAC layer within the data link layer is to control access to the physical transmission medium, such as gigabit passive optical networks (GPON) or Data Over Cable Service Interface Specification (DOCSIS) networks, and facilitate the reliable transfer of data between devices on the same network. In particular, in most network management scenarios, the MAC layer is responsible for policing and scheduling both incoming and outgoing packets.

In case of optical data networks, gigabit passive optical networks (GPON) have an equipment called an “optical line terminal” (OLT) that manages all optical network terminals (ONTs) connected to it. It implements the data link layer as well as the MAC layer contained within the data link layer. An OLT is a crucial component in a GPON (gigabit passive optical network) system. It is located at the service provider's central office or data center and serves as the endpoint of the optical distribution network (ODN). The OLT manages and controls the communication between the service provider's network and the customer premises equipment (CPE) in a GPON network.

In case of cable data networks, Data Over Cable Service Interface Specification (DOCSIS) networks have an equipment called a Cable Modem Termination System (CMTS) that manages all modems connected to it. A DOCSIS network implements the data link layer as well as the MAC layer contained within the data link layer. A CMTS is a crucial component in a DOCSIS network that serves as the central point of control for cable modem communications within the DOCSIS network. The primary function of a CMTS is to manage upstream and downstream data traffic between cable modems and the Internet.

For both GPON and DOCSIS networks, each data packet arrival is subject to a token bucket policing mechanism (i.e., for regulation of packet transmission speed at a contracted rate per subscriber), and a packet is queued if there is an available token. A scheduler manages the queues of data packets and orderly sends the packets downstream (i.e., from CMTS to modems, or from OLTs to ONTs) according to a delivery schedule. In a conventional implementation of the token bucket policing scheme in a GPON or a DOCSIS network, a token bucket filters data packets according to the contracted rate.

For example, if a subscriber's modem has a contract of 300 Mbps downstream, the token rate will deliver a maximum of 300 Mbps “packets stream” to that subscriber's modem using a scheduler. In the conventional implementation of the token bucket policing scheme, this scheduler allocates a particular bandwidth to each queue according to a particular contracted rate of a subscriber, and takes the data packets out of the queue and sends them downstream based on the contracted rate of the subscriber. One way to conceptualize the magnitude of the contracted rate is using a “service flow” (SF) model. For example, if Service Flow 1 (SF1) has twice the bandwidth of Service Flow 2 (SF2), then the scheduler is configured to deliver twice as many packets for SF1 than SF2 when queues are full.

Unfortunately, there are significant shortcomings and problems with the conventional MAC layer implementation. For example, conventional quality-of-service (QoS) enforcement methods merely allocate bandwidth statically, based on the contracted rate of a particular service flow (SF). The conventional static bandwidth allocation methods are often unable to accommodate short-term variations in demand, especially under the conditions of service oversubscriptions or conventional token bucket constraints that inhibit burst transmission. The service inefficiency and waste arising from the inflexibility of the conventional static bandwidth allocation methods often cause unsatisfactory data transmission service quality to customers and missed QoS targets.

As a case in point, the token bucket queues or discards packets when a service flow (SF) exceeds the contracted rate, even if there is bandwidth available in the data network infrastructure. Moreover, the conventional MAC layer implementation is unable to provide optimized outputs when short-time “bursts” of packet transmission fluctuations occur. If the bandwidth temporarily increases during a short period of time, data packets will be queued even if the average bandwidth is below the contracted rate.

Furthermore, in the conventional MAC layer implementation, the scheduler statically allocates the bandwidth according to the contracted rate, which results in inefficient delays of bandwidth adjustments when a Service Flow (SF) needs more bandwidth. Another shortcoming of the conventional MAC layer implementation is that all network traffic is classified as “best efforts,” unless there is reserved bandwidth. As a case in point, the conventional MAC layer implementation is unable to deliver quality-of-service (QoS) requirements, such as guaranteeing that the probability of latency exceeding 100 milliseconds is less than a specific percentage.

Therefore, it may be desirable to devise a novel electronic system and a related method of its operation that can provide more flexible and efficient MAC layer management via intelligent and dynamic allocation of available capacity in data packet queuing and downstream transmission scheduling.

In addition, it may also be desirable to devise a novel electronic system and a related method of its operation that dynamically enforces network traffic shaping, policing, and scheduling policies to ensure statistical QoS, including both throughput and latency guarantees, on a per-traffic-flow basis in GPON and DOCSIS networks.

Furthermore, it may be also desirable to devise a novel electronic system and a related method of its operation that can reliably accommodate and enforce a quality-of-service (QoS) goal in a downstream MAC layer in a predictive and adaptive manner.

Moreover, it may be also desirable to devise a novel electronic system and a related method of its operation that incorporate an intelligent traffic prediction module, which is configured to forecast how network traffic may behave in the short-term future, and utilize this traffic prediction information in future bandwidth allocation methods to improve network resource utilization and efficiency.

In addition, it may be also desirable to devise an intelligent traffic prediction module that utilizes recent network traffic averages and dynamic time interval determinations for calculating the traffic averages with a change point algorithm, wherein the change point algorithm enhances the accuracy of traffic forecasts by enabling the intelligent traffic prediction module to adapt to rapid or sudden trend changes in network traffic.

### SUMMARY

Summary and Abstract summarize some aspects of the present invention. Simplifications or omissions may have been made to avoid obscuring the purpose of the Summary or the Abstract. These simplifications or omissions are not intended to limit the scope of the present invention.

In a preferred embodiment of the invention, a quality-of-service (QoS)-based dynamic bandwidth allocation media access control (MAC) layer controller in a data network is disclosed. This QoS-based dynamic bandwidth allocation MAC layer controller comprises: (1) a default token bucket configured to enforce a network subscriber's contracted rate in a particular service flow at a default bucket monitoring interval, wherein the particular service flow is among a plurality of service flows embedded in packets arriving at the QoS-based dynamic bandwidth allocation MAC layer controller; (2) a traffic prediction module incorporated in the default token bucket, wherein the traffic prediction module is configured to generate a bandwidth requirement estimate for a next default bucket monitoring interval as a traffic prediction for the particular service flow, wherein the bandwidth requirement estimate is derived from traffic average calculations per service flow conducted by the traffic prediction module, which intelligently adjusts time window parameters used in the traffic average calculations to retain accuracy of the traffic prediction if a sudden or rapid change is detected in traffic average trends; (3) an on-demand token replenishment control module incorporated in the default token bucket, wherein the on-demand token replenishment control module is configured to trigger the default token bucket to replenish manually and earlier before the default bucket monitoring interval is fully elapsed, if the sudden or rapid change in the traffic average trends is likely to cause packet losses and give the traffic prediction module an insufficient reaction time to prevent the packet losses under the default bucket monitoring interval; and (4) a quality-of-service (QoS) scheduler configured to queue the plurality of service flows processed by the default token bucket that enforced contracted rates of a plurality of network subscribers at the default bucket monitoring interval, wherein the QoS scheduler subsequently allocates downstream transmission capacity to the plurality of service flows according to each service flow's QoS goals or requirements.

### BRIEF DESCRIPTION OF DRAWINGS

FIG. 1 shows two main components of a media access control (MAC) layer controller in a conventional MAC layer management.

FIG. 2 shows an example of a data network component incorporating a media access control (MAC) controller for MAC layer management.

FIG. 3 shows an example of internal elements of a token bucket in a media access control (MAC) layer controller.

FIG. 4 shows an example of internal elements of a scheduler in a media access control (MAC) layer controller.

FIG. 5 shows a block diagram for a novel quality-of-service (QoS)-based dynamic bandwidth allocation media access control (MAC) layer controller integrating a traffic prediction module, in accordance with an embodiment of the invention.

FIG. 6 shows an example of an algorithmic method incorporated in a novel quality-of-service (QoS) scheduler of the QoS-based dynamic bandwidth allocation MAC layer controller, in accordance with an embodiment of the invention.

FIG. 7 shows simulation results after operating the quality-of-service (QoS)-based dynamic bandwidth allocation media access control (MAC) layer controller integrating a traffic prediction module in a realistic MAC operation environment, in accordance with an embodiment of the invention.

### DETAILED DESCRIPTION

Specific embodiments of the invention will now be described in detail with reference to the accompanying figures. Like elements in the various figures are denoted by like reference numerals for consistency.

In the following detailed description of embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description.

The detailed description is presented largely in terms of description of shapes, configurations, and/or other symbolic representations that directly or indirectly resemble one or more novel quality-of-service (QoS)-based dynamic bandwidth allocation media access control (MAC) layer controller systems that integrate intelligent traffic prediction module(s) and methods of operating thereof for MAC layer management. These descriptions and representations are the means used by those experienced or skilled in the art to convey the substance of their work most effectively to others skilled in the art.

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment. Furthermore, separate or alternative embodiments are not necessarily mutually exclusive of other embodiments. Moreover, the order of blocks in process flowcharts or diagrams representing one or more embodiments of the invention does not inherently indicate any particular order nor imply any limitations in the invention.

For the purpose of describing the invention, a term herein referred to as “bandwidth” is defined as a data transmission capacity of a data network for computers and other electronic devices connected to the data network. In context of an embodiment of the present invention, a “dynamic bandwidth allocation” refers to an intelligent and flexible technique executed in one or more network layers (e.g., a media access control (MAC) layer) to reserve, distribute, and/or change the data transmission capacity of a data network for various electronic devices connected to the data network, depending on the real-time changes in input and predictive network health parameters.

Furthermore, for the purpose of describing the invention, a term herein referred to as “quality-of-service,” or “QoS,” is defined as a measurable and quantifiable parameter of data network service quality to a data network subscriber's device connected to the data network. For example, a data network guaranteeing a maximum network latency rate, or alternatively, guaranteeing the probability of latency exceeding the maximum network latency rate to be under a specific percentage to a network subscriber, is providing a quality-of-service (QoS) guarantee to the network subscriber. Other examples of QoS parameters include network service quality guarantees for upload speed or download speed over a specific period, and probability guarantees for avoiding network congestion and/or delays relative to a subscriber's contracted rate during certain hours in a day. Typically, a QoS parameter directly or indirectly impacts a network subscriber's satisfaction with a data network service provider (e.g., an Internet service provider (ISP)) over network service quality.

In addition, for the purpose of describing the invention, a term herein referred to as “module” is defined as a hardware and/or software logical unit configured to execute intended tasks and functions. A module may be implemented as a hard-coded hardware logical unit embedded in a semiconductor chip, a piece of software (e.g, a series of programming codes) stored in a data storage and executed on demand by a microprocessor, or a combination thereof. For example, in context of a preferred embodiment of the invention, a traffic prediction module and an on-demand token replenishment control module in a novel MAC layer controller may be implemented as a hard-coded hardware logical unit embedded in a semiconductor chip in one instance of the implementation, a piece of software (e.g., a series of programming codes) stored in a data storage and executed on demand by a microprocessor in another instance of the implementation, or a combination thereof in another instance of the implementation.

Moreover, for the purpose of describing the invention, a term herein referred to as “computer server” is defined as a physical computer system, another hardware device, a software module executed in an electronic device, or a combination thereof. Furthermore, in one or more embodiments of the invention, a computer server is physically or wirelessly connected to one or more data networks, such as a local area network (LAN), a wide area network (WAN), an optical data network, a cellular network, and the Internet. Moreover, in one or more embodiments of the invention, a group of computer servers may be flexibly scaled up or down to constitute a cloud computing network to process large volumes of data packets over the network and to execute a quality-of-service (QoS)-based dynamic bandwidth allocation at the media access control (MAC) layer.

One aspect of an embodiment of the present invention is providing a novel electronic system and a related method of its operation that enable flexible and efficient MAC layer management via intelligent and dynamic allocation of available network capacity in data packet queuing and downstream transmission scheduling.

Another aspect of an embodiment of the present invention is providing a novel electronic system and a related method of its operation that can reliably accommodate and enforce a quality-of-service (QoS) goal in a downstream MAC layer in a predictive and adaptive manner.

Another aspect of an embodiment of the present invention is providing a novel electronic system and a related method of its operation that incorporate an intelligent traffic prediction module, which is configured to forecast how network traffic may behave in the short-term future, and utilize this traffic prediction information in future bandwidth allocation methods to improve network resource utilization and efficiency.

Another aspect of an embodiment of the present invention is providing an intelligent traffic prediction module that utilizes recent network traffic averages and dynamic time interval determinations for calculating the traffic averages with a change point algorithm, wherein the change point algorithm enhances the accuracy of traffic forecasts by enabling the intelligent traffic prediction module to adapt to rapid or sudden trend changes in network traffic.

Yet another aspect of an embodiment of the present invention is providing a novel quality-of-service (QoS)-focused dynamic bandwidth allocation method to a data network service provider to enhance its network subscriber satisfaction rates in terms of minimized network congestions, speed degradations, unnecessary packet droppages, and downtimes.

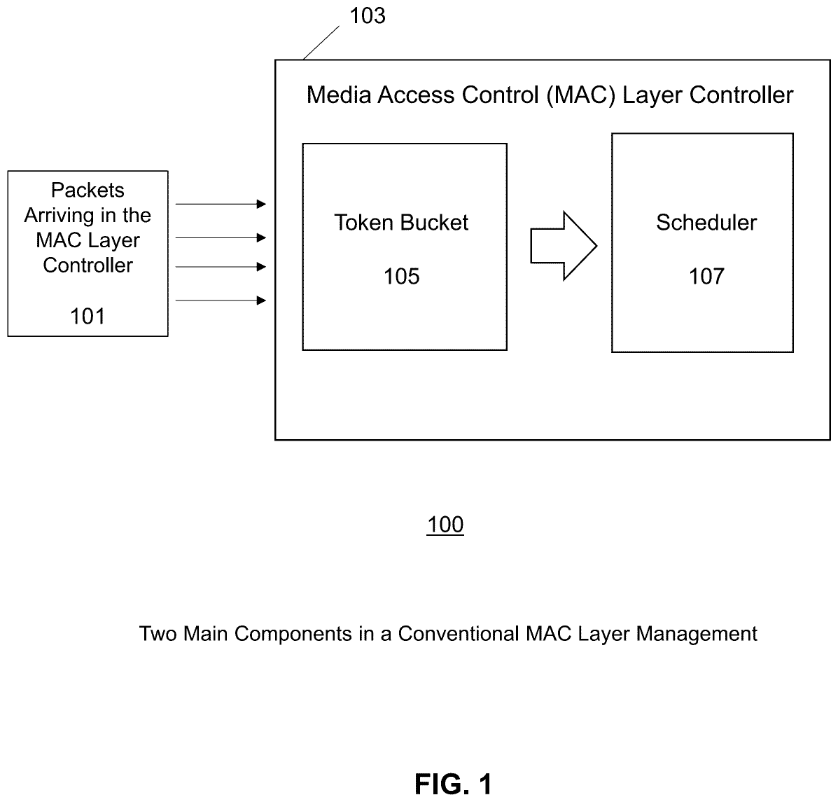

In broadband data networks, hybrid fiber cable (HFC) networks and gigabit Ethernet passive optical networks (GPON) are two predominant technologies that are widely utilized by network operators. FIG. 1 shows two main components (105, 107) of a media access control (MAC) layer controller (103) in a conventional media access control (MAC) layer management (100). Both HFC networks and GPON utilize similar downstream traffic management techniques based on a token bucket (105) and a scheduler (107) that typically uses weighted fair queueing (WFQ). In a typical MAC layer management configuration as shown in FIG. 1, the token bucket (105) filters packets (101) arriving in the media access control (MAC) layer controller (103) in an attempt to ensure that each packet's profile is compliant with a data network subscriber's contracted rate with the network service provider. Furthermore, the scheduler (107) is configured to share the downstream transmission capacity among various incoming packet traffic flows associated with multiple subscribers based on each subscriber's contracted rate.

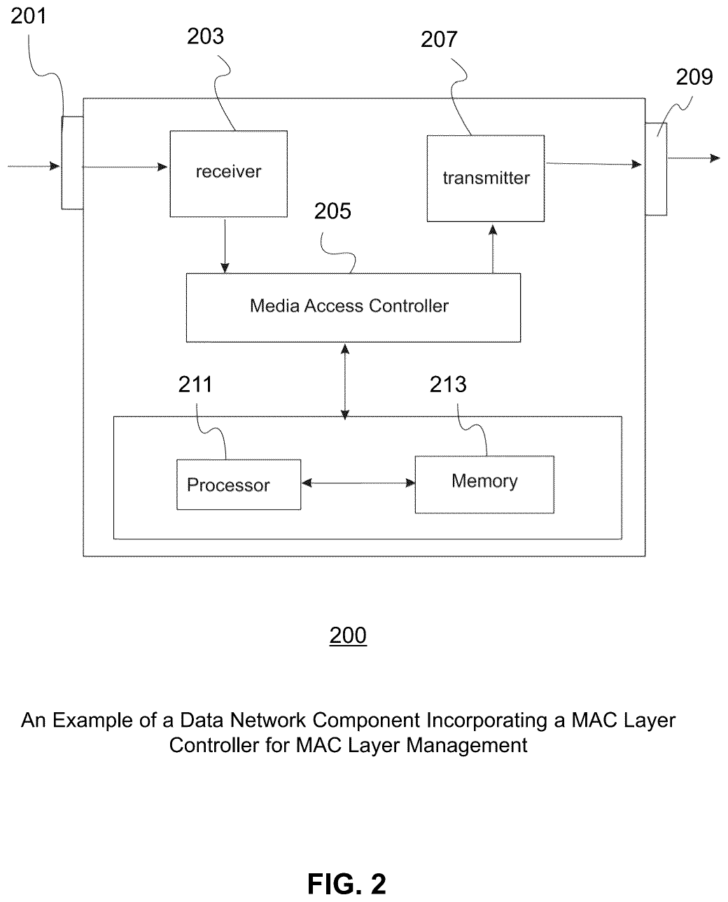

FIG. 2 shows an example of a data network component (200) incorporating a media access control (MAC) controller (205) for MAC layer management. The media access control (MAC) layer controller (103) that incorporates the token bucket (105) and the scheduler (107), as previously described in association with FIG. 1, is an example of the MAC controller (205), which is further integrated into the data network component (200) in FIG. 2. In the example as illustrated in FIG. 2, the data network component (200) comprises an input connection (201), a receiver unit (203) that receives data packets through the input connection (201), the MAC controller (205), a processor unit (211), which may be a central processing unit (CPU) or an application processing unit (APU) that provides controlling instructions to the MAC controller (205), a memory unit (213) that stores instructions and data, and a transmitter unit (207) connected to an output connection (209) that sends the processed data packets based on packet priorities and subscriber contracted rates.

The data network component (200) as illustrated in FIG. 2 is compliant with a Cable Modem Termination System (CMTS) and Data Over Cable Service Interface Specification (DOCSIS), which are widely utilized in broadband data networks. In this instance, DOCSIS specifies the media access control (MAC) layer and physical layer standards for broadband Internet delivered over a hybrid fiber cable (HFC) network. In a DOCSIS network, a CMTS has fiber connections to an upstream router to the Internet and to downstream fiber-to-coaxial nodes near subscribers. In many instances of network implementation, these downstream nodes are configured to translate traffic received on the fiber to relay to subscriber cable modems via coaxial cable, forming a Hybrid Fiber-Coaxial network. Typically, a CMTS connects to tens of fiber-to-coaxial nodes, and each node serves a segment of cable modems that share the coaxial medium.

In most network implementations, the CMTS is configured to control how cable modems access the shared coaxial medium. The DOCSIS specifies an asymmetric data path, with upstream (i.e., modem to CMTS to Internet) and downstream (i.e., Internet to CMTS to modem) data flows on separate frequencies. In DOCSIS 3.1, for example, the upstream bandwidth is 1 Gbps and the downstream bandwidth is up to 10 Gbps. The upstream communication in DOCSIS 3.1 uses a time division algorithm to split across flows, whereas the downstream communication is broadcast within a shared coaxial segment, with subscribers' modems configured to only read their own messages.

In a typical residential configuration, the CMTS regulates one downstream service flow (SF) per modem for all traffic flows except voice, with Quality of Service (QoS) parameters for maximum sustained traffic rate, which is the subscriber's data plan, peak traffic rate (i.e., often 1.5×-2.5× the maximum sustained rate), and maximum burst size. The CMTS controls this downstream traffic via token buckets, assuring that flows do not exceed their configured rates. Each service flow comprises a queue, a QoS parameter, and classifiers. Service flows are largely independent from each other.

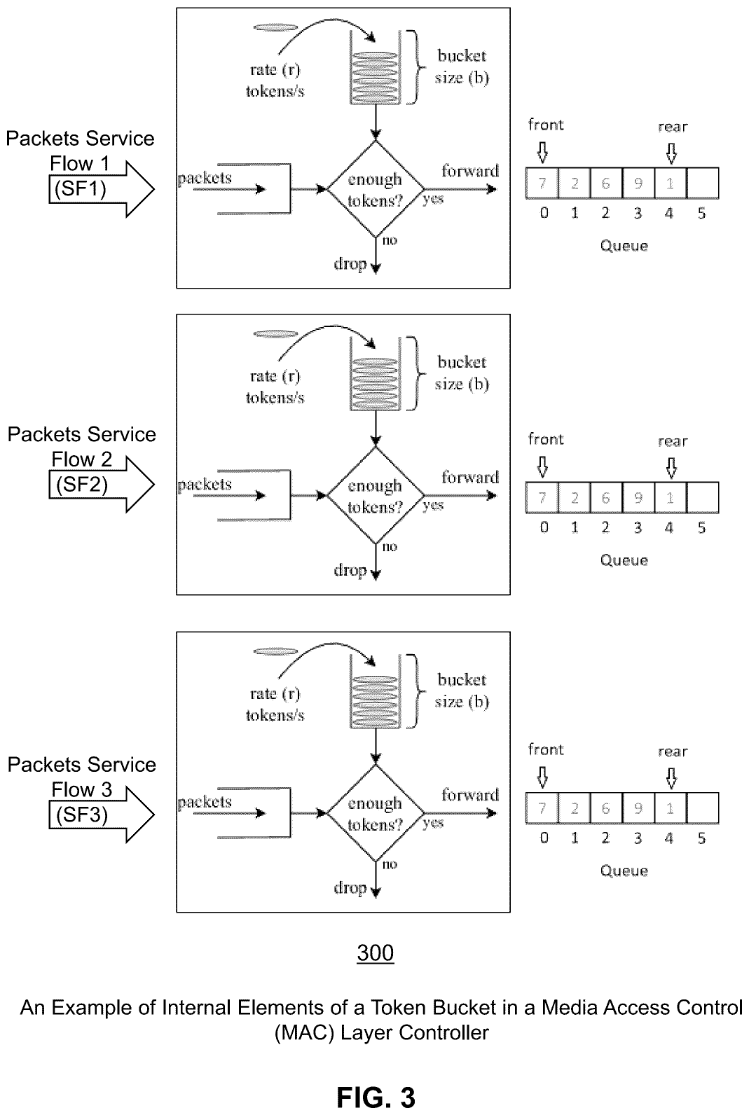

FIG. 3 shows an example (300) of internal elements of a token bucket in a media access control (MAC) layer controller. In this example (300), three service flows of packets (i.e., SF1, SF2, SF3) are independently processed by corresponding token buckets, each of which is assigned with rate tokens for a particular bucket size, based on each subscriber's contracted rate as indicated or implied, for instance, by the incoming packet(s). If a sufficient number of rate tokens is accumulated in a token bucket for a particular time period (e.g., 1 millisecond (ms)) and is in compliance with the subscriber's contracted rate, then that token bucket places the associated incoming service flow of packets (i.e., SF1, SF2, or SF3) in the queue for downstream processing. A packet is queued if there is an available token. In contrast, if the number of rate tokens is insufficient for an incoming service flow of packets for a particular time period (e.g., 1 ms), then that service flow of packets is either: (1) dropped from further processing and denied from being placed in the queue for downstream transmission, or (2) withheld for later processing.

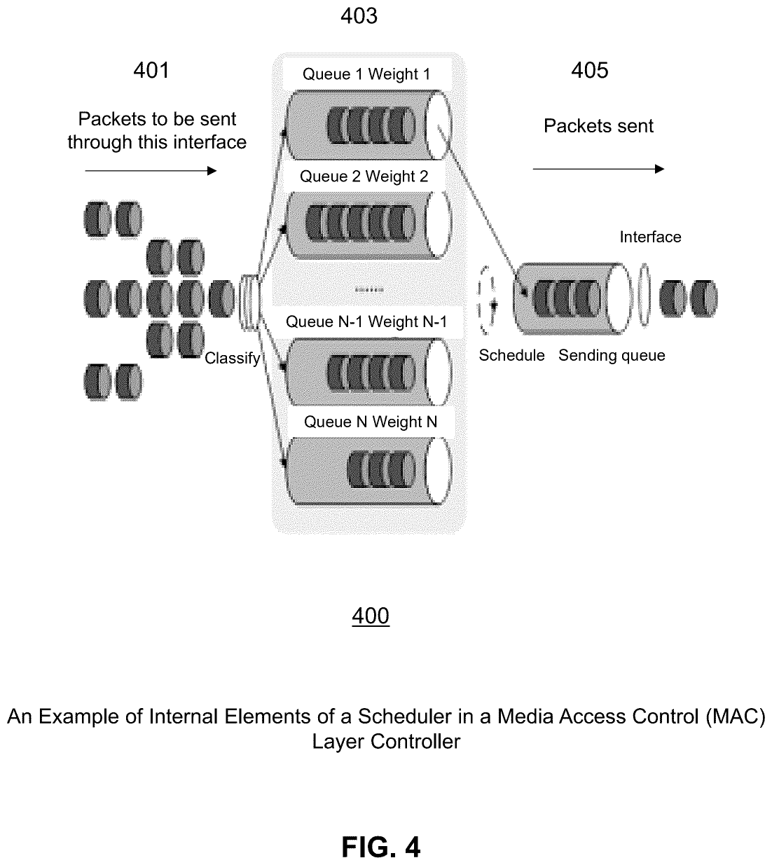

FIG. 4 shows an example (400) of internal elements of a scheduler in a media access control (MAC) layer controller. As illustrated in this example (400), packets (401) to be sent through this scheduler interface is classified, categorized, and placed into one or more queues (403) prior to downstream transmission. Typically, the queues (403) utilize a weighted fair queuing (WFQ) scheduler, with implementations of the WFQ varying from one network service provider to another. In general, the WFQ allows the scheduler to specify, for each service flow, which fraction of the transmission capacity will be given based on transmission priority that may have been defined, for example, by subscribers' contracted rates of transmission. The service flow of packets placed in the queues (403) is then systematically transmitted out downstream as outgoing, or “sent” packets (405), as illustrated in FIG. 4. This transmission process may optionally involve an additional “sending queue” interface at the output terminal of the scheduler for seamless transmission of the outgoing packets (405).

As shown in the example (400) in FIG. 4, the scheduler manages the queues (403) of data packets (401), and orderly sends the packets downstream (i.e., from CMTS to modems, or from OLTs to ONTs) according to a delivery schedule. In a conventional implementation of the token bucket policing scheme in a GPON or a DOCSIS network, a token bucket filters data packets according to the contracted rate. For example, if a subscriber's modem has a contract of 300 Mbps downstream, the token rate will deliver a maximum of 300 Mbps “packets stream” to that subscriber's modem using a scheduler. In the conventional implementation of the token bucket policing scheme, this scheduler allocates a particular bandwidth to each queue according to a particular contracted rate of a subscriber, and takes the data packets out of the queue and sends them downstream based on the contracted rate of the subscriber. One way to conceptualize the magnitude of the contracted rate is using a “service flow” (SF) model. For example, if Service Flow 1 (e.g., SF1 in FIG. 3) has twice the bandwidth of Service Flow 2 (e.g., SF2 in FIG. 3), then the scheduler, as shown in FIG. 4, is configured to deliver twice as many packets for SF1 than SF2 when queues (403) are full.

Unfortunately, there are significant shortcomings and problems with the conventional MAC layer implementation. For instance, the token bucket queues or discards packets when a service flow (SF) exceeds the contracted rate, even if there is bandwidth available in the data network infrastructure. Moreover, the conventional MAC layer implementation is unable to provide optimized outputs when short-time “bursts” of packet transmission fluctuations occur. If the bandwidth temporarily increases during a short period of time, data packets will be queued even if the average bandwidth is below the contracted rate.

Mathematically, what is enforced is that the data traffic placed on DOCSIS downstream link given by TXBytes in the time interval T=(t1, t2) complies with the following rate equations:

$$TXBytes ( t 1 , t 2 ) <= ( t 2 - t 1 ) * R / 8 + B$$

$$TXBytes ( t 1 , t 2 ) <= ( t 2 - t 1 ) * P / 8 + 1522$$

for all values t2>t1 where:
R=Maximum Sustained Traffic Rate (bps)
P=Peak Traffic Rate (bps)
B=Maximum Traffic Burst (bytes)
   If the load that a SF places on the link is less than the Maximum Sustained Traffic Rate, the SF earns credit that can be used to burst at the Peak Traffic Rate when the load increases. This dynamic is important because these rate changes can induce a step function in buffering latency.

After passing through these rate limiters, the CMTS schedules the traffic for delivery across the shared medium via a Weighted Fair Queueing (WFQ) algorithm, which may be customized and specific to a particular implementation by a vendor utilized by a data network provider. Most vendors only use the WFQ to differentiate network traffic flows according to their reserved bandwidth, which means that most of the residential traffic, including adaptive bitrate (ABR) streaming video, merely utilizes the same conventional “best effort” output queue.

In the current state of the art in data network management, cable networks oversubscribe customer data plans relative to network bandwidth, with typical worldwide overbooking ratios of 10:1 to 200:1. This oversubscription causes short millisecond-scale congestion intervals, during which some service flows may receive less than their maximum rate. If there is insufficient available bandwidth during peak hours, the maximum rate of all service flows is scaled back by the same percentage.

In a GPON network, the network structure is similar to the HFC (i.e., DOCSIS) network as described above, with a major difference being that fiber, and not a coaxial cable, goes up to the end-user premises. A typical GPON link has 1.24416 Gbps upstream and 2.48832 Gbps downstream, which is usually shared among 64 or 128 users. The Optical Line Terminal (OLT) equipment is similar to the CMTS. It receives traffic from the Internet router and transmits it downstream to several Optical Network Units (ONU), which connect to the end-user devices. A GPON network has a similar downstream traffic management algorithm to the HFC network, with a token bucket policy mechanism and a WFQ scheduler.

In one or more embodiments of the present invention, an optimized MAC layer management implementation with an underlying system (i.e., a novel quality-of-service (QoS)-based dynamic bandwidth allocation media access control (MAC) layer controller) and a method of operating the system are disclosed. In a preferred embodiment of the invention, the optimized downstream MAC layer may benefit by incorporating all of the following three primary objectives: (1) rate goal: enforcing contracted rates; (2) work-conserving goal: making efficient use of available capacity, by aiming to schedule traffic whenever the channel is free and at least one flow has demand; and (3) QoS goal: attempting to allocate capacity to satisfy QoS goals with network subscribers whenever possible. In contrast to the three objectives that will be satisfied in one or more embodiments of the present invention, conventional DOCSIS and GPON MAC layers only succeed in managing the first objective (i.e., rate goal). In particular, a conventional scheduler in the current state of the art is unable to achieve the second objective (i.e., work-conserving goal) or the third objective (i.e., QoS goal), which are desirable for improved optimization of the downstream MAC layer.

In a typical MAC layer management environment, each network traffic source arrives into a queue which is initially filtered by a token bucket mechanism. The filtered traffic from individual sources is scheduled downstream by a weighted fair-queueing (WFQ) scheduler, with the implementation varying by vendors. The physical (PHY) layer allocates data packets to their respective channels. The token bucket, which defines the maximum number of bytes sent in any departure period T, may be characterized by an equation, Max(T)=T*(R/8)+B, where R is the rate limit and B is the maximum traffic burst.

Even if the aggregate demand across all packet flows does not exceed the available downstream bandwidth, the token bucket filters and queues each arriving packet flow in the conventional MAC layer implementation, thus hampering the arriving flows from achieving the work-conserving goal (i.e., making efficient use of available capacity, by aiming to schedule traffic whenever the channel is free and at least one flow has demand). The inefficient behavior of the conventional approach in MAC layer management fails to provide effective optimizations in network traffic management, when short-lived spikes that exceed R occur in individual flows. In case of congestion, when an aggregate demand exceeds downstream capacity, the conventional scheduler reduces all service flow token rate proportional to their contracted token rate, thus also failing to provide any intelligent optimizations with respect to the work-conserving goal.

Furthermore, the conventional MAC layer is also insufficient to achieve the QoS goal (i.e., attempting to allocate capacity to satisfy QoS goals with network subscribers whenever possible). Conventional MAC layer management attempts to provide QoS guarantees to particular traffic by reserving bandwidth for the traffic. However, reservations make provisioning dedicated capacity to be at odds with the work-conserving goal, and Internet service providers (ISPs) typically only utilize such reservations for a few applications, such as voice and corporate services. Most network traffic of data packets, including ABR video, gaming, video-conferencing, and web browsing, only receives “best effort” service, which is insufficient to provide consistent, let alone guaranteed, quality-of-service (QoS) experience to users. Because the satisfactory user experience fundamentally depends on consistency and reliability of network performance and optimization options, an embodiment of the present invention discloses a novel MAC protocol, called “Velocity and Acceleration Network Management” (VAN), to achieve all of the three primary objectives of an optimized MAC layer implementation.

In a preferred embodiment of the invention, an optimized and novel MAC layer controller implementation in the VAN is configured to evaluate instantaneous QoS requirements of each service flow, and to allocate network resources dynamically to meet short-term QoS targets, such as latency minimization, while still ensuring compliance with long-term contracted rates for network subscribers. A key component of the novel MAC layer controller in the VAN is a traffic prediction module that anticipates future QoS violations by analyzing trends in network metrics. For instance, if the traffic prediction module forecasts a potential breach of latency threshold in the next scheduling interval, the Velocity and Acceleration Network Management (VAN) proactively adjusts resource allocation (e.g., increasing bandwidth or reducing buffer depth) to prevent degradation.

This novel approach to predict and smartly accommodate real-time changes to network traffic is enabled by proactively adjusting, if necessary, near-term future bandwidth allocations in anticipation of probable, sudden, or rapid network traffic changes. The proactive bandwidth allocation adjustments based on a robust prediction of probable, sudden, and/or rapid network traffic changes achieve a desirable and sustained delivery of high-quality user experiences, such as uninterrupted and low-latency video conferencing even under fluctuating traffic conditions. Unlike the conventional static approaches to a MAC layer management, various embodiments of the present invention that incorporate network traffic change prediction methods and dynamic bandwidth allocation methods that utilize such robust predictions are able to maintain statistical QoS guarantees over time and adapt dynamically to the evolving network state on a per-flow basis.

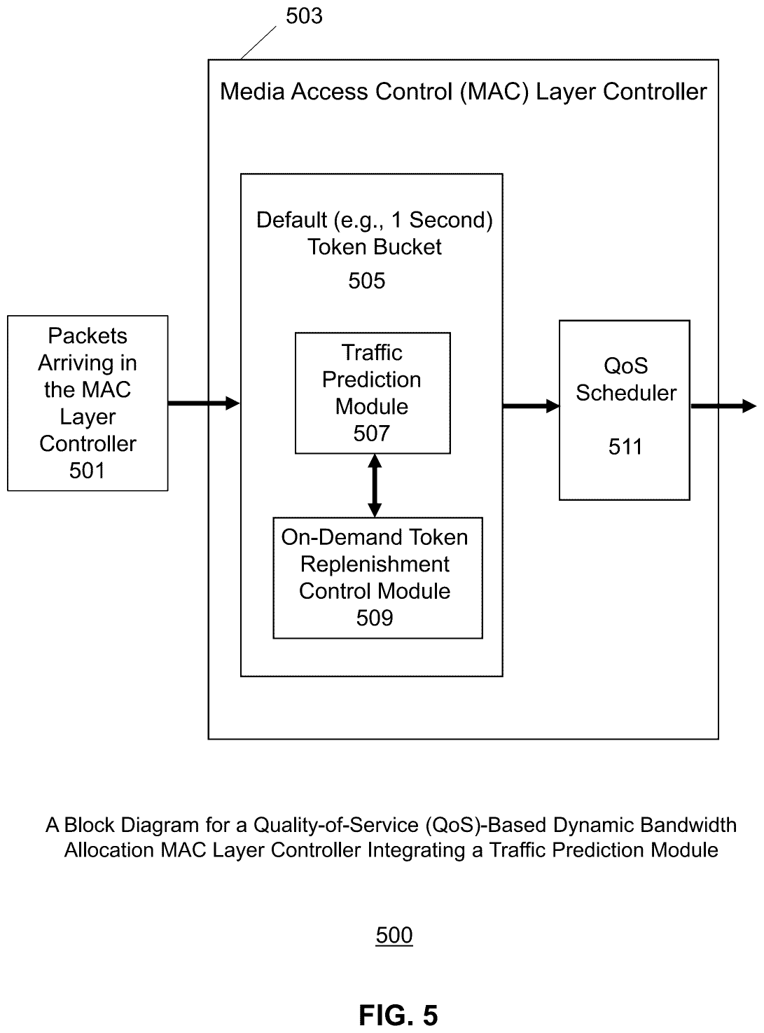

FIG. 5 shows a block diagram (500) for a novel quality-of-service (QoS)-based dynamic bandwidth allocation media access control (MAC) layer controller integrating a traffic prediction module, in accordance with an embodiment of the invention. In a preferred embodiment of the invention, the Velocity and Acceleration Network Management (VAN) comprises at least three components in its media access control (MAC) layer controller (503), as illustrated by the block diagram (500) in FIG. 5: (1) a default token bucket (505) configured to enforce a contracted rate at a larger time granularity (e.g., 1 second) than conventional token bucket filtering time granularities (e.g., 1 millisecond or a few milliseconds) for packets (501) arriving in the MAC layer controller (503); (2) a traffic prediction module (507) configured to adjust an allocated bandwidth to each service flow (SF) based on its network traffic behavior to manage available bandwidths to multiple SFs as efficiently as possible without degrading data transmission quality to each SF; and (3) a QoS scheduler (511) that allocates downstream transmission capacity according to a given service flow's QoS goals or requirements.

In the preferred embodiment of the invention, the traffic prediction module (507) is configured to generate a bandwidth requirement estimate for a next default bucket monitoring interval as a traffic prediction for a particular service flow. This bandwidth requirement estimate is derived from traffic average calculations per service flow conducted by the traffic prediction module (507), which intelligently adjusts time window parameters used in the traffic average calculations to retain accuracy of the traffic prediction if a sudden or rapid change is detected in traffic average trends.

Optionally, the default token bucket (505) in the MAC layer controller (503) also incorporates an on-demand token replenishment control module (509) that triggers the default token bucket (505) to replenish manually (i.e., typically for only one monitoring cycle) before a default monitoring time interval (e.g., 1 second) has fully elapsed. The on-demand token replenishment may be useful in certain situations in which a network traffic increases very rapidly and causes the traffic prediction module (507) to not have sufficient time to react and increase the allotted bandwidth before packet losses are incurred.

In one example of activating the earlier token replenishment, for every cycle (e.g., t=100 ms, 1 second, etc.), if the traffic average in the current cycle computed by the traffic prediction module (507) for a particular service flow is much higher than the traffic average computed in the previous cycle, then a smaller-scale time interval for calculating traffic averages becomes desirable for increasing or maintaining the accuracy of the traffic prediction module (507). The smaller-scale time interval for calculating traffic average is determined by detecting a change point in the traffic average patterns. If the change point is detected, then the on-demand token replenishment control module (509) may force a token replenishment to the default token bucket (505), even before the default time interval (e.g., 1 second) is fully elapsed in the current bucket monitoring cycle.

The earlier and manual (i.e., on-demand) token replenishment in the event of a change point detection (i.e., for sudden and/or rapid change(s) in traffic averages between token bucket monitoring cycles) improves the accuracy of traffic predictions by enabling the traffic prediction module (507) to react more rapidly to sudden and/or rapid changes in traffic averages per service flow, which in turn assists the VAN and the MAC layer controller (503) to allocate required and/or optimized bandwidths proactively and dynamically, even before most of the packets experiencing sudden and/or rapid changes need to be processed by the VAN and the MAC layer controller (503).

Furthermore, in some cases, the computed traffic averages for a service flow in the traffic prediction module (507) may be very small (e.g., smaller than 20 percent of the contracted rate of the service flow), and two techniques, either separately or in combination, may be utilized to increase the bandwidth allocation to this service flow without violating the principle of average rate allocation: (1) the computed traffic average for the service flow is multiplied by a factor of two or another desirable numerical factor, and this multiplied value may be defined as the newly-allocated bandwidth to this service flow; (2) if the computed traffic average for the service flow is smaller than 20 percent of the contracted rate, then assign this value (i.e., 20 percent of the contracted rate) as the newly-allocated bandwidth to this service flow.

In the preferred embodiment of the invention as shown in FIG. 5, the traffic prediction module (507) and the on-demand token replenishment control module (509) are both integrated into the default token bucket (505) in the novel QoS-based dynamic bandwidth allocation MAC layer controller (503). It is important to note that conventional token buckets in conventional MAC layer controllers do not exhibit the novel concepts of intelligent traffic predictions and on-demand token replenishments for dynamic and adaptive bandwidth allocations for network efficiency and QoS satisfaction improvements, let alone uniquely incorporating such traffic prediction and on-demand token replenishment modules into a token bucket.

Furthermore, in the preferred embodiment of the invention, at least some of the default token bucket (505), the traffic prediction module (507), the on-demand token replenishment control module (509), and the QoS scheduler (511) are embedded software stored in a data storage unit (e.g., a non-volatile memory unit, a hard disk drive, another localized data storage, etc.) in the novel QoS-based dynamic bandwidth allocation MAC layer controller (503) data network component. These embedded software stored in the data storage unit are then executed, as needed, in a central processing unit (CPU), an application processing unit (APU), and/or a volatile memory unit of the novel QoS-based dynamic bandwidth allocation MAC layer controller (503) data network component, or in a computer server connected in the data network. In another embodiment of the invention, at least some of the default token bucket (505), the traffic prediction module (507), the on-demand token replenishment control module (509), and the QoS scheduler (511) are embedded software or machine codes integrated into an application-specific integrated circuit (ASIC) semiconductor chip in the novel QoS-based dynamic bandwidth allocation MAC layer controller (503).

In the preferred embodiment of the invention, the default token bucket (505) in the novel QoS-based dynamic bandwidth allocation MAC layer controller (503) monitors and enforces each subscriber's contracted rate at a one-second interval instead of shorter time intervals (e.g., 1 millisecond), which had been an industry standard in conventional token buckets in conventional MAC layer controllers. In context of the preferred embodiment of the invention, the default token bucket (505) can be interchangeably called a “one-second token bucket,” because the default monitoring interval is set at one second. In other embodiments of the invention, the default token bucket (505) may have a default monitoring interval shorter or longer than one second, depending on the usefulness of a particular length of the bucket monitoring interval in a particular MAC layer controller implementation.

As shown in the block diagram (500) in FIG. 5, the subscriber rate enforcement at a substantially longer time interval (e.g., 1 second) than the conventional industry-standard and shorter time interval (e.g., 1 millisecond) involves refilling the default token bucket (505) at each second, instead of at each millisecond. The longer time interval in the default token bucket (505) (i.e., by a factor of 100 to 1000 compared to the industry-standard shorter interval) allows an incoming service flow (SF) to fluctuate within the longer time interval as long as the incoming SF adheres to the contracted rate at the one-second interval.

The longer time interval in the default token bucket (505) improves network efficiency and QoS satisfaction measures by enhancing flexible accommodation of short and bursty traffic in the incoming SF, especially because typical bursts are shorter than one second in most cases. Furthermore, since the default token bucket (505) sized to the one-second interval can contain a much larger number of tokens, compared to conventional 1 millisecond-interval token buckets, the default token bucket (505) in the novel QoS-based dynamic bandwidth allocation MAC layer controller (503) can frequently accommodate short bursts of network traffic without emptying the bucket. Because each subscriber's contracted rate is still enforced at every second in the VAN implementation of the QoS-based dynamic bandwidth allocation MAC layer controller (503), the rate goal objectives are still fully satisfied while enhancing the overall network transmission efficiencies and the QoS satisfaction measures.

The objective of the VAN is to satisfy three goals simultaneously: (1) rate goal; (2) work-conserving goal; and (3) QoS goal. At first glance, the three objectives of the VAN may seem at odds with each other. The rate goal requires enforcing contract rates, seemingly limiting the amount of traffic that can be sent per flow and restricting the ability to achieve the work-conserving goal. Further, if flows that experience high bursts are shaped to the contracted rate, they may experience queueing delays or buffer overflow losses, which potentially interferes with the QoS goal. However, the Velocity and Acceleration Network Management (VAN), as incorporated in the preferred embodiment of the present invention, is able to fulfill the three stated objectives simultaneously and synergistically based on the following four approaches:

First, the VAN measures the arrival rate of the service flows (SFs) at longer time intervals to accommodate bursty traffic. It refills the token bucket at each second instead of at each millisecond, which allows a SF to fluctuate within this time interval as long as the SF adheres to the contracted rate at every second. Typical bursts are significantly shorter than one second, and because the one-second token bucket contains a large number of tokens, it can frequently accommodate short bursts without emptying the bucket. However, within the one second period, contracted rates are still enforced, thus satisfying the rate goal.

The VAN is able to achieve the rate goal by enforcing contract rates over a more flexible and longer time scales relative to conventional approaches. By stretching the time frame over which it calculates and enforces the rate, the VAN cleverly attains freedom and flexibility, compared to conventional MAC layer management schemes, to consider the other two remaining goals (i.e., work-conserving goal, QoS goal) at finer timescales and a better ability to deal with bursty and oscillating traffic of data packets, which are pervasive, for example, in the video ABR traffic.

Second, in order to accommodate the bursty and oscillating traffic at finer timescales, the VAN allows the service flows (SF) to temporarily burst over their contracted rate if there are remaining capacity. In context of the block diagram (500) example in FIG. 5, this means that the packets accumulated in the default token bucket (505) may be allowed to have bursty and oscillating traffic, as long as the rate goal objective is not violated during a longer monitoring time interval (e.g., 1 second) than the industry-standard conventional monitoring time interval (e.g., one or a few milliseconds). The temporary accommodation of the bursty traffic for the SF enables the VAN to accomplish the work-conserving goal (i.e., making efficient use of available capacity, by aiming to schedule traffic whenever the channel is free and at least one flow has demand), while still not defying the objectives of the rate goal (i.e., enforcing contracted rates for each subscriber). In contrast, the conventional MAC layer management schemes would have dropped the accumulating packets for the rate goal violation under the rigidity of the conventional and shorter monitoring time interval (e.g., one or a few milliseconds).

Third, the VAN is configured to regulate the burst rates by allocating extra capacity, compared to traditional MAC protocols, to service flows that are in danger of incurring excessive queueing delay or queue overflow loss, and by temporarily reallocating the capacity from other service flows that either have limited demand or flexibility to absorb additional delay without violating QoS goals. By dynamically adjusting allocations of network transmission and/or processing capacity, the VAN is able to achieve the QoS goal (i.e., attempting to allocate capacity to satisfy QoS goals with network subscribers whenever possible) without defying the objectives of the rate goal and the work-conserving goal.

In context of the block diagram (500) in FIG. 5, the QoS-based dynamic bandwidth allocation MAC layer controller (503) in the VAN may utilize the default token bucket (505), the traffic prediction module (507), the on-demand token replenishment control module (509), and/or the QoS scheduler (511) to assign and adjust downstream transmission capacity dynamically to multiple service flows of data packets in order to satisfy the QoS goal, while still complying to the objectives of the rate goal and the work-conserving goal in the MAC layer management.

Fourth, in order to best achieve the QoS goal, the QoS scheduler (511) in the VAN's MAC layer controller (503) looks not only at the contracted rate, but also at the traffic pattern of a service flow. In particular, the traffic prediction module (507) incorporated into the default token bucket (505) in the VAN's MAC layer controller (503) is able to project how much traffic is likely to arrive soon.

By projecting impending need, the VAN can proactively allocate sufficient capacity to each service flow to serve its needs while also optimizing available capacity for all service flows. Because the network traffic is below the contracted rate most of the time, and because the VAN dynamically calculates the traffic predicted for the next period in the traffic prediction module (507), the VAN is able to allocate traffic more efficiently and save an available bandwidth safely without the problems associated with an oversubscription arising mostly from conventional static bandwidth allocation methods.

Furthermore, the QoS scheduler (511) in the VAN's MAC layer controller (503) is able to factor QoS preferences and a required capacity into account in packet scheduling tasks to achieve latency needs in its scheduling algorithm. As a result, since capacity constraints have been handled by the default token bucket (505), the QoS scheduler (511) can flexibly allocate bandwidths preferentially to low-latency service flows. In some embodiments of the invention, the QoS scheduler (511) is also configured to recognize how much traffic of data packets is likely to arrive soon to the MAC layer controller (503) by utilizing traffic prediction information from the traffic prediction module (507). By projecting an impending need of network traffic processing, the MAC layer controller (503) in the VAN can be proactive, for example, by preemptively clearing the queue to prepare a likely-needed queuing capacity for the anticipated service flow without disrupting QoS targets.

Moreover, by generating reliable short-term traffic predictions by calculating recent traffic averages per service flow and by detecting sudden and/or rapid trend changes in the traffic averages, the traffic prediction module (507) provides the Internet Service Provider (ISP) connected to the MAC layer controller (503) some invaluable information to understand the current traffic behaviors and trends in its data network, which in turn enables the ISP to allocate resources more efficiently.

For example, the traffic prediction module (507) in FIG. 5 is configured to generate a bandwidth requirement estimate for a next default bucket monitoring interval as a traffic prediction for a particular service flow. This bandwidth requirement estimate is derived from traffic average calculations per service flow conducted by the traffic prediction module (507), which is also capable of intelligently adjusting time window parameters used in the traffic average calculations to retain accuracy of the traffic prediction, if a sudden or rapid change is detected in traffic average trends. Therefore, the traffic prediction module (507) is able to determine, at any time, a near-term bandwidth requirement for each service flow, which allows the ISP to allocate network bandwidths and other resources precisely. By knowing how much bandwidth is needed at any time per service flow, the ISP can reroute the less-utilized bandwidth in one service flow to another service flow that is predicted to be at risk of congestion, from the traffic prediction information generated by the traffic prediction module (507) in the MAC layer controller (503).

It should be noted that the conventional oversubscription model, which is widely utilized in the conventional data network management practices, assumes that the clients use only a fraction of their contracted rates. Unfortunately, this assumption is often imprecise and inflexible in real-world network management, because the ISP is unable to change the resource allocation strategy proactively or rapidly in response to network inefficiency-causing events (e.g., sudden and/or rapid changes in some service flows within the network). In the conventional oversubscription model, the ISP is merely able to adjust the oversubscription rate slowly and imprecisely, for example, by adding or removing clients from CMTS or OLT ports to maximize network usage and minimize congestion.

In contrast, the QoS-based dynamic bandwidth allocation MAC layer controller (503) integrating the traffic prediction module (507) empowers the ISP to respond to and potentially resolve any predicted network inefficiencies proactively and automatically in real time. For example, the traffic prediction information from the traffic prediction module (507) enables the QoS-based dynamic bandwidth allocation MAC layer controller (503) and the rest of the dynamic bandwidth allocation system in the VAN to provide much better response time and accuracy than the conventional oversubscription model for network management by smartly and proactively re-allocating of network bandwidths and resources, if the traffic patterns are changing or predicted to change suddenly or rapidly to cause network service disruptions, congestions, or other inefficiencies. The QoS-based dynamic bandwidth allocation MAC layer controller (503) integrating the traffic prediction module (507) is able to determine the network usage in the OLT/CMTS by each port at any time, and is able to allocate a precisely desirable amount of bandwidth to each port to minimize the likelihood of an underutilization, a congestion, and a waste of the allocated bandwidth simultaneously.

It should be noted that conventional MAC flow control mechanisms use a token bucket that enforces a Cruz bound, which can be defined as follows: the amount of traffic allowed within a time T is given by (Max(T)=T*(R/8)+B), where R is the token rate and B is the buffer size. The token bucket constrains burstiness in the traffic exiting the CMTS/OLT, and such bounds enable deterministic bounds on the burstiness, delay, and buffering requirements downstream in the network. However, for network traffic with high oscillations, which occur, for example, in video ABR traces, unless R is much higher than the traffic's average rate, the token bucket causes long queues and packet losses. These problems occur even if downstream capacity exists and even if the flow only exceeds R when considered over relatively short time intervals. Analysis of the network traffic with high oscillations has demonstrated that the conventional, inflexible, and strict rate enforcement can cause unnecessary and inefficient network congestions, annoying service delays, and unsatisfied customers who are subscribed to a data network.

The inefficiencies of the conventional token bucket in the conventional MAC layer management system are not necessarily caused by the rates of the service flow (SF) monitoring itself, but by the time granularity of filtering and monitoring intervals that the conventional token bucket utilizes to police the SF. Typically, the conventional token bucket enforces rates at a very small-time granularity of filtering/monitoring intervals (e.g., approximately 1-10 millisecond time window). Large bursts, which occur often in some network traffic (e.g., in ABR videos), can consume a small token bucket fast, even though the large bursts may provide an acceptable network performance over a longer monitoring interval that a typical conventional token bucket does not utilize.

Therefore, in the preferred embodiment of the invention, the default token bucket (505) in the QoS-based dynamic bandwidth allocation MAC layer controller (503) is configured to have a much larger time granularity (e.g., τ=1 second). The traffic can oscillate freely within τ while guaranteeing that the average rate of the traffic for a service flow does not exceed the contracted rate on a period of time greater than τ. Because the SF adheres to its contracted rate at the one-second time scale in this instance, the QoS-based dynamic bandwidth allocation MAC layer controller (503) allows the incoming service flow to oscillate within the one-second bucket monitoring time interval, which is about 100 to 1000 times longer than the conventional bucket monitoring intervals in conventional MAC layer implementations.

Typical data packet transmission bursts in a network are shorter than one second, as in the case of video transmissions, which are some of the most common sources of network traffic. A typical burst can transmit up to about ten times more data than permitted by the contracted rate in a few milliseconds. A token bucket containing one second worth of transmission capacity can easily accommodate such bursts, in contrast to a conventional and inflexible rate enforcement that uses a much shorter-interval bucket monitoring scheme (e.g., 1 ms) that would prevent this burst transmission and cause network resource management inefficiencies.

The traffic prediction module (507) in the preferred embodiment of the invention utilizes a common trait of network traffic, where the bandwidth required to transmit a service flow tends to converge to the network traffic average. If a traffic source is “well behaved” in accordance with this common trait, then the average bandwidth will be a good prediction of future network traffic patterns. However, real traffic sources are not “well behaved” in the sense that there is no well-defined average, as the average traffic for a service flow changes over time. For example, the average bandwidth required to transmit a video at 4K resolution is much higher than the bandwidth required to transmit the video at full high-definition (HD). Because video streaming services typically change the resolution dynamically, determining a single average for a service flow may be inaccurate or misleading. However, under certain conditions, such as staying fixed at a specific video resolution during transmission or within a specified time interval, the data streamed may be characterized as “well behaved,” for which making an accurate and reliable bandwidth prediction using short-term or “local” traffic averages.

In the preferred embodiment of the invention, the QoS-based dynamic bandwidth allocation MAC layer (503) utilizes the “one-second token bucket” as its default token bucket (505), with a bucket monitoring and filtering interval of one second, which is 100˜1000 times longer than the conventional bucket monitoring and filtering interval of 1˜10 milliseconds typically used in the conventional MAC layer management. Importantly, the traffic prediction module (507) incorporated in the default token bucket (505), as shown in the preferred embodiment of the invention in FIG. 5, uniquely utilizes a change point algorithm for determining and flexibly adjusting appropriate time intervals for calculating short-term (i.e., “local”) traffic averages per service flow.

In an initial or default condition, the average bandwidth per service flow is initially computed at every second, and this initial condition is then utilized to determine when the traffic average changes and when new time window parameters should be used for calculating the short-term traffic averages more accurately, if there are sudden and/or rapid changes detected by the change point algorithm during the traffic average calculations by the traffic prediction module (507).

For the purpose of disclosing the theoretical and the mathematical basis of the operation of the traffic prediction module (507), let there be a discrete time system with time intervals of one hundred milliseconds (100 ms). Let
Y(t) be the workload arriving at time t defined by number of bits arriving during this time interval.
V(t)=Y(t)−Y(t−1)/t be the velocity at time t in bits per time interval.
A(t)=(V(t)−V(t−1)/t be the acceleration at time t.

Then, compute the averages V̅(t) and Y̅(t) over a window defined by the change point algorithm, t′ is the time the last change point was detected.

$$\overline{V} ( t + 1 ) = \frac{{\sum }_{i = {t}^{′}}^{t} V ( i )}{t - {t}^{′}}$$

$$\overline{A} ( t + 1 ) = \frac{{\sum }_{i = {t}^{′}}^{t} A ( i )}{t - {t}^{′}}$$

σ_{A(t)} is equal to the standard deviation of A(t) over the same window.

Then, define \hat{V}(t+1) as the velocity estimator for the traffic at time t+1 as a function of the values of V̅(t), Ā(t), and σ_{A(t)} as

$$\hat{V} ( t + 1 ) = \overline{V} ( t ) + \overline{A} ( t ) + {σ}_{A ( t )}$$

The bandwidth needed for the next second is therefore the average bandwidth already computed plus Y(t)+\hat{V}(t+1), which define the allocation for the next period. It would also be important to demonstrate, using a change point algorithm, how to identify periods (i.e., time intervals) in which a traffic average is determined.

In order to determine the time intervals for computing an accurate traffic average, the traffic prediction module (507) utilizes a change point algorithm that detects when the average changes suddenly and/or rapidly, which typically indicates a nontrivial change in the overall trend of the average. By identifying regions with stable averages and by recognizing sudden or rapid changes in the calculated traffic averages via an execution of the change point algorithm, an optimally-efficient and adequate bandwidth allocation (i.e., per service flow) can be predicted for a short-term future period (e.g., between a current bucket monitoring cycle and a subsequent bucket monitoring cycle) as an output of the traffic prediction module (507).

For example, in the preferred embodiment of the invention, the output of the traffic prediction module (507) forecasts and/or determines the bandwidth required for the subsequent bucket monitoring cycle (e.g., one second, if the default bucket monitoring cycle is set to be one second), which is the “short-term future period” that the forecasts from the traffic prediction module (507) is considered useful and valid by the QoS dynamic bandwidth allocation MAC layer controller (503) and the rest of the VAN network. This forecasted short-term future traffic information can be utilized by the VAN network to determine how much bandwidth is allocated to each service flow in the next bucket monitoring cycle.

For instance, if there are ten subscribers in one port, and if 10 Mbps-worth of total bandwidths are forecasted (i.e., by the traffic prediction module (507)) to be utilized by these ten subscribers in aggregate for the next bucket monitoring cycle, the OLT and/or the CMTS can reserve and dynamically allocate 10 Mbps for this particular port for the next bucket monitoring cycle. Furthermore, at some point in the future, if the total required bandwidths in aggregate for the ten subscribers in this port are forecasted to be 5 Mbps instead of 10 Mbps by the traffic prediction module (507), then the OLT and/or the CMTS can adjust bandwidth allocation downward to 5 Mbps for dynamic and resource-efficient management of bandwidth allocations to subscribers.

There are several change point algorithms that may be appropriate for utilization in the traffic prediction module (507). For example, a well-known change point algorithm compares the changes in the measurements of interest, adding these changes over time and keeping track of the net changes (i.e., maintaining their signals in which positive changes cancel negative ones). When the cumulative change goes beyond a defined threshold (i.e., normally defined in terms of the standard deviation of the sample points), a change point is determined.

From a statistical standpoint, a calculated average within two change points is assumed to be meaningful because the variance around this average corresponds to a natural variance in a bursty traffic and does not include a large variance that would correspond to a change in essential traffic parameters (e.g., a resolution change in a streaming session). Therefore, it may be desirable to use the interval between two change points for calculating traffic averages and generating traffic prediction outputs by the traffic prediction module (507). Furthermore, whenever a change point is detected, it may also be desirable to start determining a new traffic average value for use by the traffic prediction module (507).

This fluid and intelligent method for determining an appropriate time interval based on change point detections for calculating traffic averages enables dynamic and accurate identifications of and adaptations to ever-changing bandwidth requirements per service flow. An accurate understanding and near-term prediction of the changing bandwidth requirements per service flow (i.e. by the traffic prediction module (507)) allows the QoS dynamic bandwidth allocation MAC layer controller (503) and the rest of the VAN network to manage and allocate network resources efficiently, minimizing any wasted bandwidths while maintaining satisfactory QoS parameters.

In one embodiment of the invention, the traffic prediction module (507) integrated into the default token bucket (505) in the QoS dynamic bandwidth allocation MAC layer controller (503) utilizes an initial default condition of considering a new change point at every second. This embodiment of the traffic prediction module (507), at its initial default condition, computes a new average of the network traffic at each second per service flow, and uses that average and associated speeds and acceleration (e.g., computed at every 100 ms interval) as embodied in the VAN to allocate bandwidth to each service flow for the next period of one second. This simplified algorithm for utilizing the new change point detection can be used whenever a more sophisticated or comprehensive change point detection algorithm cannot be utilized, for example, in situations that cannot provide necessary processing power requirements for executing the more sophisticated or comprehensive change point detection algorithm in the QoS dynamic bandwidth allocation MAC layer controller (503). Furthermore, in some instances of traffic pattern analysis and predictions, the simplified algorithm for change point detection may be preferred over the more sophisticated or comprehensive change point algorithms because the performance outputs are very similar to begin with.

In a preferred embodiment of the invention, the default token bucket (505) in the QoS dynamic bandwidth allocation MAC layer controller (503) has a one-second bucket monitoring interval, and the number of tokens is replenished at every second using the expected traffic defined by the traffic prediction module (507). In many real-world cases of network traffic management, the one-second bucket monitoring interval works quite effectively to minimizes potentially wasteful and exorbitant bandwidth allocations to service flows at the expense of a slightly-higher packet loss, compared to conventional millisecond bucket monitoring interval schemes. However, occasional burstiness in some service flows in a network can generate peaky traffic that the one-second bucket monitoring interval, as utilized in the QoS dynamic bandwidth allocation MAC layer controller (503), may be too slow to react in time to prevent or reduce packet losses.

Therefore, the QoS dynamic bandwidth allocation MAC layer controller (503) utilizes additional and novel innovative techniques and methods, as disclosed herein, to minimize such packet losses during bursty service flows while still maintaining network bandwidth management and allocation efficiencies. In particular, in the preferred embodiment of the invention, the default token bucket (505) in the MAC layer controller (503) incorporates an on-demand token replenishment control module (509) that triggers the default token bucket (505) to replenish manually (i.e., typically for only one monitoring cycle) before a default monitoring time interval (e.g., 1 second) has fully elapsed. The on-demand token replenishment may be useful in certain situations in which a network traffic increases very rapidly and causes the traffic prediction module (507) to have insufficient time to react and increase the allotted bandwidth before packet losses are incurred.

In one example of activating the earlier token replenishment, for every cycle (e.g., t=100 ms, 1 second, etc.), if the traffic average in the current cycle computed by the traffic prediction module (507) for a particular service flow is much higher than the traffic average computed in the previous cycle, then a smaller-scale time interval for calculating traffic averages becomes desirable for increasing or maintaining the accuracy of the traffic prediction module (507). The smaller-scale time interval for calculating traffic average is determined by detecting a change point in the traffic average patterns. If the change point is detected, then the on-demand token replenishment control module (509) may force a token replenishment to the default token bucket (505), even before the default time interval (e.g., 1 second) is fully elapsed in the current bucket monitoring cycle.

The earlier and manual (i.e., on-demand) token replenishment in the event of a change point detection (i.e., for sudden and/or rapid change(s) in traffic averages between token bucket monitoring cycles) improves the accuracy of traffic predictions by enabling the traffic prediction module (507) to react more rapidly to sudden and/or rapid changes in traffic averages per service flow, which in turn assists the VAN and the MAC layer controller (503) to allocate required and/or optimized bandwidths proactively and dynamically, even before most of the packets experiencing sudden and/or rapid changes need to be processed by the VAN and the MAC layer controller (503).

Furthermore, in some cases, the computed traffic averages for a service flow in the traffic prediction module (507) may be very small (e.g., smaller than 20 percent of the contracted rate of the service flow), and two techniques, either separately or in combination, may be utilized to increase the bandwidth allocation to this service flow without violating the principle of average rate allocation: (1) the computed traffic average for the service flow is multiplied by a factor of two or another desirable numerical factor, and this multiplied value may be defined as the newly-allocated bandwidth to this service flow; (2) if the computed traffic average for the service flow is smaller than 20 percent of the contracted rate, then assign this value (i.e., 20 percent of the contracted rate) as the newly-allocated bandwidth to this service flow.

In a preferred embodiment of the invention, the QoS scheduler (511) in the VAN and the MAC layer controller (503) attempts to allocate enough capacity to satisfy both latency and throughput requirements for each source at each departure interval. In many cases, it may be desirable to model the system as a discrete time (i.e., t∈[1 . . . ∞]) queueing system. In this model, there are k independent queues sharing a common departure link with constant departure rate at a given capacity, C. The departure interval has size δt, and the QoS requirements are defined by the following variables in this model:
Lᵢ is the maximum latency in seconds for each source i.
Nᵢ(t)=number of bits in queue of source i at time t.

$${B}_{m}^{i}$$

is the minimum capacity to be allocated to source i, given by Mbps.

$${B}_{c}^{i} ( t ) = min ( {B}_{m}^{i} , \frac{{N}_{i} ( t )}{δ t} ) .$$

It is the minimum between the minimum capacity and the capacity needed to send all bits in the queue. It is the minimum bandwidth needed to satisfy the throughput requirements.

$${B}_{l}^{i} ( t ) = \frac{{N}_{i} ( t )}{{L}_{i}}$$

if Lᵢ<∞, zero otherwise. It is the capacity needed to be allocated to achieve the minimum latency requirement in Mbps. For example, if Lᵢ=10 milliseconds and Nᵢ(t)=1 M bits then

$${B}_{l}^{i} ( t ) = 20 Mbps$$

$${B}^{i} ( t ) = max ( {B}_{c}^{i} ( t ) , {B}_{l}^{i} ( t ) )$$

is the capacity that needs to be allocated to source i at time t to satisfy both latency and minimum throughput QoS requirements.
Cⁱ(t) is the capacity that is effectively allocated to source i at time t.

There are two special cases for the QoS scheduler (511) as mathematically modeled above:
1. If Lᵢ=1 and

$${B}_{c}^{i} ( t ) = 0$$

for all t, then the scheduler is a weighted fair queueing scheduler
2. if Lᵢ=∞ then

$${B}_{l}^{i} ( t ) = 0 and {B}_{c}^{i} ( t )$$

is equal to the contracted rate, then the scheduler works as the same as current GPON and DOCSIS scheduler. It will schedule it source according to its contract rate.

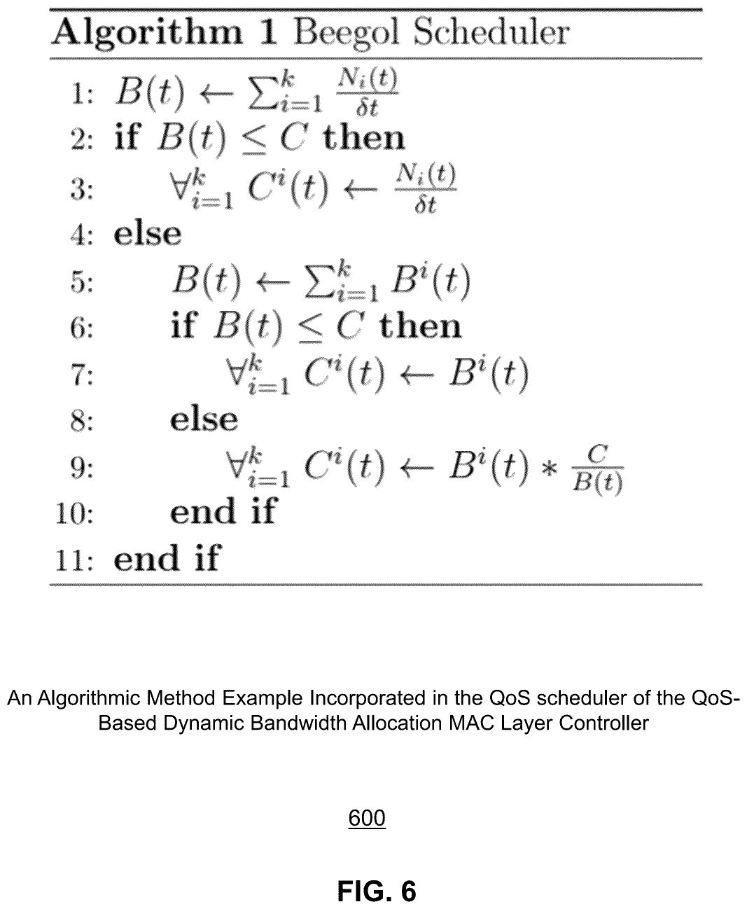

The QoS scheduler (511) in the preferred embodiment, as modeled above, is also compatible with existing and conventional packet scheduling methods while also exhibiting a unique advantage of minimizing latency and maintaining minimum contracted rates for subscribers. FIG. 6 shows an algorithmic method example (600) of the innovative QoS scheduler (i.e., 511 in FIG. 5) that were mathematically modeled and described in previous paragraphs. In the preferred embodiment of the invention, the algorithmic method example (600), as illustrated in FIG. 6, is incorporated and executed by the QoS scheduler (i.e., 511 of FIG. 5) of the QoS-based dynamic MAC layer controller (i.e., 503 in FIG. 5).

Line 1 in the algorithmic method example (600) for the QoS scheduler in FIG. 6 determines the total capacity needed to serve all requests. This respects the work conserving principle. If there is enough capacity, the VAN and QoS-based dynamic MAC layer controller, as embodied in the present invention, is configured to serve all the unfinished work in the system, as shown in Lines 2˜3. Since the token bucket is able to monitor and police the incoming rates for each service flow, it is reasonable to assume that no arriving service flow will exceed its contract rate during a token bucket interval. Line 5 in the algorithmic method example (600) for the QoS scheduler computes the capacity required to satisfy the QoS requirements. Then, Line 7 allocates this capacity, if possible, after checking as a conditional “if” statement (i.e., Line 6) whether there is enough capacity (C) to serve all QoS requirements. Otherwise, if there is insufficient capacity to serve all QoS requirements, then as shown in Line 9, this algorithmic method for the QoS scheduler decreases capacity proportionally to all requests. Furthermore, as an optional step, if there is a leftover capacity after serving all of the needs of the service flows, the leftover capacity may be allocated according to a fair-queueing scheduler in the preferred embodiment of the invention.

In another embodiment of the invention, the QoS scheduler (511) in FIG. 5 may be mathematically and alternatively modeled as follows. Before describing the novel QoS scheduler implemented in this alternate embodiment in more detail, it may be useful to define the QoS goal analytically. To describe VAN's QoS goals, an embodiment of the present invention models the system as a discrete time, work-conserving queueing system. In this embodiment, there are “k” independent service flow arrival processes, defined as SFi, where i is in [1 . . . k], feeding k independent queues.

The independent service flow arrival processes share a common departure link with maximum departure rate C. The VAN is configured to inspect the system at each departure time, t. Let
Nᵢ(t) be the workload (in bytes) in the queue at time t for service flow i.

$$N ( t ) = {\sum }_{i = 1}^{k} {N}_{i} ( t )$$

be the aggregate workload in the system at time t for all queues

There are a few considerations for the QoS scheduler in a work-conserving queueing system: (1) Total workload in the system (N(t)) does not depend on the scheduler mechanics; and (2) The workload on each queue Nᵢ(t) at time t depends on the scheduler mechanism. Let
Aᵢ(t)=be arrival workload (in bytes) at time t for service flow i.

$$A ( t ) = {\sum }_{i = 1}^{k} {A}_{i} ( t )$$

be the total arrival workload (in bytes) at time t.
Cᵢ(t)=capacity (in bytes) allocated to SFᵢ at time t.

$$\begin{matrix}{N}_{i} ( t + 1 ) = max ( 0 , {N}_{i} ( t ) + {A}_{i} ( t ) - {C}_{i} ( t ) ) \\ {N}_{i} ( 0 ) = 0\end{matrix}$$

In this embodiment of the invention, the QoS is defined as a function of maximum latency and minimum bandwidth of SFᵢ at each time slot given by:
Lᵢ=maximum workload (in bytes) of each SFᵢ at each time t in the queue i.
Bᵢ=minimum capacity allocated to each SFᵢ at each time t (bytes per time slot).
   Furthermore, the QoS goal can be mathematically defined herein as:
Minimize t∈[. . . ∞] such as Cᵢ(t)≤Bᵢ and Nᵢ(t)≥Lᵢ
δₜ=size of the time slot
   Because both requirements, latency and bandwidth, are concurrent, the needed capacity given by C^{qos} can be expressed as C^{qos}=max (Bᵢ,Lᵢ) to serve both latency and bandwidth.

In this embodiment of the invention, the scheduler algorithm comprises two steps, first to allocate the capacity according to the QoS goal, and second to allocate, if available, the remaining capacity according to a typical WFQ algorithm:
(1.1) If N(t)<C, serve all packets in every SF queue. This is the working-conserving goal. The VAN serves all packets if there is enough capacity. The flow control algorithm takes care of the contracted rate. The scheduler does not need to police the traffic.
(1.2) Otherwise, for each SFᵢ, the VAN estimates

$${C}_{i}^{qos} ( t )$$

(1.2.1)

$${C}^{q o s} = {\sum }_{i = 1}^{k} {C}_{i}^{qos} ( t )$$

(1.2.2) For each SFᵢ, the VAN allocates capacity according to the following logic:
   (1.2.3) if C<C^{qos}, then

$${C}_{i} ( t ) = {C}^{q o s} / C * {C}_{i}^{q o s} ( t )$$

(1.2.4) if C>C^{qos}, then

$${C}_{i} ( t ) = {C}_{i}^{q o s} ( t )$$

This is the QoS goal where capacity is allocated to achieve a given QoS
(2.1) If there is leftover capacity after allocating C^{qos} given by C_{leftover}=(C−C^{qos})>0, then the VAN allocates C_{leftover} according to the WFQ algorithm.

In this embodiment of the invention, the VAN guarantees the capacity allocation initially to achieve the QoS and then the remaining capacity is allocated using a conventional WFQ method, according to the workload in each queue. The VAN, which incorporates the QoS-based dynamic bandwidth allocation MAC layer controller (e.g., 503 in FIG. 5), is a discrete time system with time intervals t (time slots) of one hundred milliseconds (100 ms). At each time slot, there may be a packet arrival defined in bits.

Let Y(t) be the workload arriving at time t defined by number of bits arriving during this time interval t:
V(t)=Y(t)−Y(t−1)/t be the velocity at time t in bits per time interval
A(t)=(V(t)−V(t−1)/t be the acceleration at time t.
   In order to create an effective estimator, \hat{V}(t+1), the VAN is configured to compute the averages V̅(t) and Y̅(t) over a sliding window of size 10. Furthermore, the VAN can define the conditions as follows:

$$\overline{V} ( t + 1 ) = {\sum }_{i = t - 10}^{t} V ( i ) ,$$

where i is in [10 . . . ∞]

$$\overline{A} ( t + 1 ) = {\sum }_{i = t - 10}^{t} A ( i ) ,$$

where i is in [10 . . . ∞]
σ_{A(t)} is equal to the standard deviation of A(t) over the same sliding window of t=10
Therefore,

$$\hat{V} ( t + 1 ) = \overline{V} ( t ) + \overline{A} ( t ) + / - σ A ( t )$$

In this embodiment of the invention, the VAN is configured to operate under three different scenarios, assuming that the naïve estimator is defined as \hat{V}(t+1)=V(t):

$$\hat{V} ( t + 1 ) = \overline{V} ( t ) \qquad Scenario 1$$

$$\hat{V} ( t + 1 ) = \overline{V} ( t ) + \overline{A} ( t ) \qquad Scenario 2$$

$$\hat{V} ( t + 1 ) = \overline{V} ( t ) + \overline{A} ( t ) ++ / - σ A ( t ) \qquad Scenario 3$$

In this alternate embodiment of the invention, the performance of the traffic prediction module can be estimated by computing the Mean Absolute Error (MAE) for these three scenarios. In one empirical case, a greater than 90 percent accuracy in traffic prediction was achieved using realistic network traffic data samples.

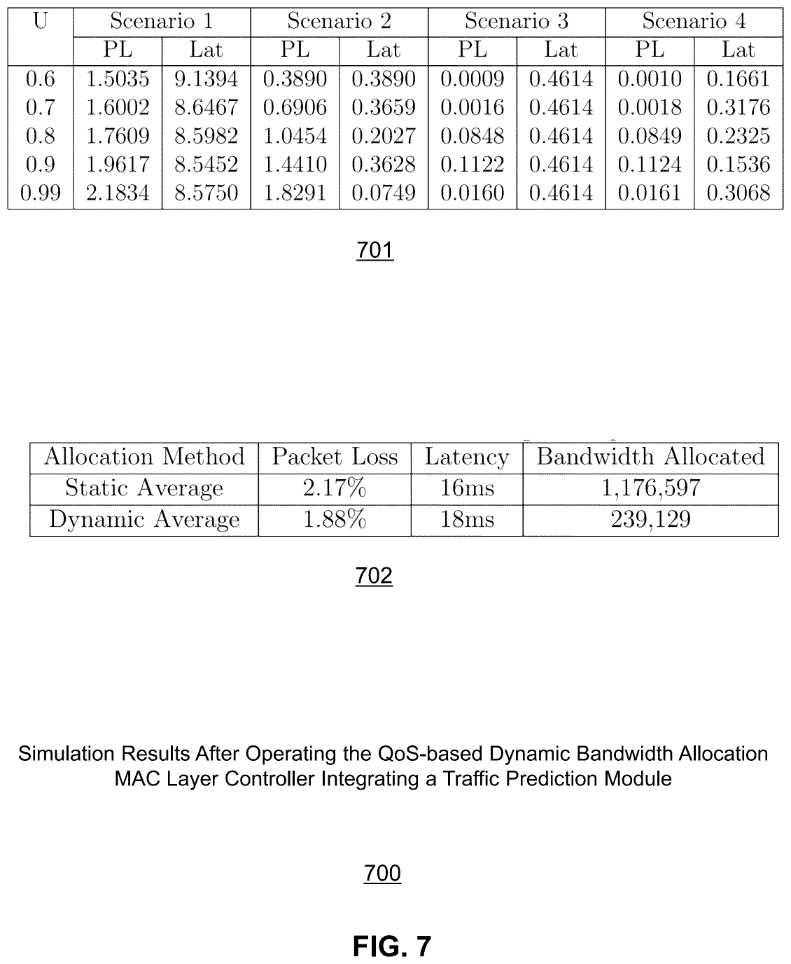

FIG. 7 shows simulation results (700) after operating the quality-of-service (QoS)-based dynamic bandwidth allocation media access control (MAC) layer controller integrating the traffic prediction module in a realistic MAC operation environment, in accordance with an embodiment of the invention. The simulation results (700) shown in FIG. 7 are generated from a MAC simulator that has a token bucket and a scheduler as its two components. In order to test realistic network traffic situations, ten different real network traffic sources are utilized to collect traffic data for executing the simulation tests. These network traffic sources correspond to real traffic patterns and include regular low traffic as well as higher and bursty video service (e.g., Netflix, YouTube, etc.) transmissions. The following four distinct scenarios were executed in the MAC simulator for realistic tests:
1. Scenario 1: Conventional short-interval (i.e., 1 ms) token bucket with conventional DOCSIS and GPON scheduler based on the contracted rate.
2. Scenario 2: Conventional short-interval token bucket with a conventional Weighted Fair Queueing (WFQ) scheduler which shares bandwidth in proportion to each flow needs, not necessarily restricted to the contracted rate.
3. Scenario 3: One-Second token bucket with the conventional WFQ scheduler.
4. Scenario 4: One-Second token bucket with the novel QoS scheduler as disclosed in the preferred embodiment of the present invention.

As shown in a first simulation table (701) in FIG. 7, this test measured both packet loss (PL) and average latency (Lat) for the four scenarios at different network utilization (U) values. During simulation, both queuing and transmission capacity were restricted to ensure that the load approached the transmission capacity of the channel. These conditions were effective for testing differentiated behaviors of token buckets under the four scenarios, and the simulation results are illustrated in the first simulation table (701) in FIG. 7. The simulation results clearly show that the conventional DOCSIS scheduler in “Scenario 1” performs particularly poorly at the contracted rates. Gains of up to four times in packet loss reduction and up to one order of magnitude in latency can be obtained by switching from the DOCSIS scheduler to the WFQ scheduler, as used in “Scenario 2”.

Furthermore, as shown in “Scenario 3”, the one-second token bucket with the conventional WFQ scheduler yields an additional improvement, with improvements up to two orders of magnitude in packet loss reduction. However, the conventional WFQ scheduler with the one-second token bucket in “Scenario 3” actually increases latency, compared to “Scenario 2” that utilized the conventional short-interval token bucket. In any case, the reduction in packet loss in “Scenario 3” can be considered to be a worthy tradeoff to a slight increase in latency, if the network operator believes that it is better to have some delays rather than outright packet losses.

More advantageously, the one-second token bucket with the novel QoS scheduler, as disclosed in the preferred embodiment of the present invention, provides the most outstanding results, as demonstrated in “Scenario 4” in the first simulation table (701) in FIG. 7. Packet losses (PL) are comparable to “Scenario 3” while latency (Lat) is significantly reduced over “Scenario 3”. This is a logical result from the simulation tests, because the novel QoS scheduler is configured to take latency into scheduling decisions, unlike the conventional WFQ scheduler. In the simulation tests as shown in the first simulation table (701), improvements in latency reductions were as high as nearly three times in “Scenario 4” in some cases, compared to “Scenario 3”.

Furthermore, as shown in a second simulation table (702) in FIG. 7, the QoS-based dynamic bandwidth allocation MAC layer controller (i.e., 503 in FIG. 5) integrating the traffic prediction module (i.e., 507 in FIG. 5) is simulated against the conventional “static” bandwidth allocation MAC layer controller in realistic network traffic situations. Several parameters of the simulation, such as the change point threshold, bandwidth multiplier, and minimum bandwidth were designed to be adjusted for different traffic sources during simulation. Test values for these parameters were chosen during the simulation tests to approximate realistic packet loss and latency from the contracted rate implementations in order to ascertain the bandwidth gains under similar conditions.

As illustrated in the second simulation table (702) in FIG. 7, the “Static Average” row considers the average bandwidth of a complete transmission session. The numbers shown in the “Static Average” row are derived from the sum of the average rates of all service flows that are being utilized. Moreover, the “Dynamic Average” row corresponds to the average computed at every second, and allocated to the next second according to the traffic prediction module. The second simulation table (702) illustrates that the simulation results from the “Dynamic Average” row that utilized the QoS-based dynamic bandwidth allocation MAC layer controller with the integrating the traffic prediction module are clearly better than the conventional “Static Average” row, with lower packet losses and comparable latencies while using only one-fifth of the bandwidth required in the conventional static allocation method.

Various embodiments of the present invention provide several key advantages in MAC layer management for data networks. One advantage of an embodiment of the present invention is providing a novel electronic system and a method of its operation that enable flexible and efficient MAC layer management via intelligent and dynamic allocation of available network capacity in data packet queuing and downstream transmission scheduling.

Moreover, another advantage of an embodiment of the present invention is providing a novel electronic system and a method of its operation that can reliably accommodate and enforce a quality-of-service (QoS) goal in a downstream MAC layer in a predictive and adaptive manner whenever possible.

In addition, another advantage of an embodiment of the present invention is providing a novel electronic system and a method of its operation that dynamically enforce network traffic shaping, policing, and scheduling policies to ensure statistical QoS, including both throughput and latency guarantees, on a per-traffic-flow basis in GPON and DOCSIS networks.

Furthermore, another advantage of an embodiment of the present invention is providing a novel electronic system and a related method of its operation that incorporate an intelligent traffic prediction module, which is configured to forecast how network traffic may behave in the short-term future, and utilize this traffic prediction information in future bandwidth allocation methods to improve network resource utilization and efficiency.

In addition, another advantage of an embodiment of the present invention is providing an intelligent traffic prediction module that utilizes recent network traffic averages and dynamic time interval determinations for calculating the traffic averages with a change point algorithm, wherein the change point algorithm enhances the accuracy of traffic forecasts by enabling the intelligent traffic prediction module to adapt to rapid or sudden trend changes in network traffic.

Furthermore, another advantage of an embodiment of the present invention is providing a novel quality-of-service (QoS)-focused dynamic bandwidth allocation method to a data network service provider to enhance its network subscriber satisfaction rates in terms of minimized network congestions, speed degradations, and downtimes.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A quality-of-service (QoS)-based dynamic bandwidth allocation media access control (MAC) layer controller in a data network comprising:
a default token bucket configured to enforce a network subscriber's contracted rate in a particular service flow at a default bucket monitoring interval, wherein the particular service flow is among a plurality of service flows embedded in packets arriving at the QoS-based dynamic bandwidth allocation MAC layer controller;
a traffic prediction module incorporated in the default token bucket, wherein the traffic prediction module is configured to generate a bandwidth requirement estimate for a next default bucket monitoring interval as a traffic prediction for the particular service flow, wherein the bandwidth requirement estimate is derived from traffic average calculations per service flow conducted by the traffic prediction module, which intelligently adjusts time window parameters used in the traffic average calculations to retain accuracy of the traffic prediction if a sudden or rapid change is detected in traffic average trends;
an on-demand token replenishment control module incorporated in the default token bucket, wherein the on-demand token replenishment control module is configured to trigger the default token bucket to replenish manually and earlier before the default bucket monitoring interval is fully elapsed, if the sudden or rapid change in the traffic average trends is likely to cause packet losses and give the traffic prediction module an insufficient reaction time to prevent the packet losses under the default bucket monitoring interval; and
a quality-of-service (QoS) scheduler configured to queue the plurality of service flows processed by the default token bucket that enforced contracted rates of a plurality of network subscribers at the default bucket monitoring interval, wherein the QoS scheduler subsequently allocates downstream transmission capacity to the plurality of service flows according to each service flow's QoS goals or requirements.

2. The QoS-based dynamic bandwidth allocation MAC layer controller of claim 1, wherein the default bucket monitoring interval is one second.

3. The QoS-based dynamic bandwidth allocation MAC layer controller of claim 1, wherein the traffic prediction module is configured to detect the sudden or rapid change in the traffic average trends by utilizing a change point algorithm, and then adjusting the time window parameters to a smaller-scale time interval for the traffic average calculations when the sudden or rapid change in the traffic average trends is detected.

4. The QoS-based dynamic bandwidth allocation MAC layer controller of claim 1, wherein the traffic prediction module uses a multiplication factor of 2, or 20 percent of the network subscriber's contracted rate as the bandwidth requirement estimate for the next default bucket monitoring interval, if the traffic average calculations are less than 20 percent of the network subscriber's contracted rate.

5. The QoS-based dynamic bandwidth allocation MAC layer controller of claim 1, wherein the QoS scheduler simultaneously prioritizes a work-conserving goal that makes efficient use of available network capacity by aiming to schedule traffic whenever possible and a QoS goal that attempts to allocate network capacity to provide satisfactory QoS to subscribers whenever possible.

6. The QoS-based dynamic bandwidth allocation MAC layer controller of claim 1, wherein the QoS-based dynamic bandwidth allocation MAC layer controller is incorporated into a data network equipment for gigabit passive optical networks (GPON) or Data Over Cable Service Interface Specification (DOCSIS) networks.

7. The QoS-based dynamic bandwidth allocation MAC layer controller of claim 1, wherein at least one of the default token bucket, the traffic prediction module, the on-demand token replenishment control module, and the QoS scheduler is executed in at least one of a central processing unit (CPU), an application processing unit (APU), and a memory unit of the QoS-based dynamic bandwidth allocation MAC layer controller or a computer server connected to the QoS-based dynamic bandwidth allocation MAC layer controller in the data network.

8. The QoS-based dynamic bandwidth allocation MAC layer controller of claim 1, wherein at least one of the default token bucket, the traffic prediction module, the on-demand token replenishment control module, and the QoS scheduler is physically integrated as embedded machine codes in an application-specific integrated circuit (ASIC) semiconductor chip in the QoS-based dynamic bandwidth allocation MAC layer controller.
